(19) United States
(12) Patent Application Publication
(10) Pub. No.: US 2022/0101645 A1
(43) Pub. Date: Mar. 31, 2022

(54) METHOD AND DEVICE FOR PROCESSING IMAGE HAVING ANIMAL FACE

(71) Applicant: BEIJING BYTEDANCE NETWORK TECHNOLOGY CO., LTD., Beijing (CN)

(72) Inventors: Shentao WANG, Beijing (CN); Hui Yang, Beijing (CN); Le GAO, Beijing (CN); Xiaoqi LI, Beijing (CN); Yanhao SHEN, Beijing (CN); Guangyao NI, Beijing (CN)

(21) Appl. No.: 17/425,579

(22) PCT Filed: Dec. 27, 2019
(86) PCT No.: PCT/CN2019/129119

§ 371 Date: Jul. 23, 2021

(30) Foreign Application Priority Data
Jan. 25, 2019 (CN) 201910073609.4

(51) Int. Cl. G06V 40/10; G06V 10/44; G06T 11/00

(52) U.S. Cl. CPC G06V 40/10; G06T 2207/20081; G06T 11/001; G06V 10/44

(57) ABSTRACT

A method and device for processing an image having an animal face, an electronic device, and a computer-readable storage medium. The method for processing an image having an animal face comprises: acquiring an input image, the image comprising at least one animal; recognizing a facial image of the animal in the image; reading a configuration file for image processing, the configuration file comprising image processing parameters; and processing the facial image of the animal according to the image processing parameters to obtain the processed facial image of the animal.

### CROSS REFERENCE OF RELATED APPLICATION

The present application claims priority to Chinese Patent Application No. 201910073609.4, titled “METHOD AND DEVICE FOR PROCESSING IMAGE HAVING ANIMAL FACE”, filed on Jan. 25, 2019 with the Chinese Patent Office, which is incorporated herein by reference in its entirety.

### FIELD

The present disclosure relates to the field of image processing, and particularly to a method and an apparatus for processing an animal face image, an electronic device and a computer readable storage medium.

### BACKGROUND

With the development of computer technologies, the application range of smart terminals has been extensively improved. For example, smart terminals can be used to listen to music, play games, chat online, and take photos. For the camera technology of the smart terminal, the camera pixel has reached more than 10 million pixels, which has a relative high definition and a camera effect comparable to that of a professional camera.

At present, when using smart terminals to take photos, not only a built-in camera software at the factory can be used to realize traditional functions of taking pictures, but also an application (referred to as an APP) downloaded from the network can be used to realize additional functions of taking pictures. For example, some APPs can be used to realize functions such as dark light detection, beautification cameras, and super pixels. The beautification function of the smart terminal usually includes beautification processing effects such as skin tone adjustment, skin grinding, eye making bigger, and face thinning, which can perform a certain degree of beautification processing on the face that has been recognized in the image.

However, the current cameras and APPs generally only optimize or process human faces to a certain extent, and do not process faces of other animals. Various pets such as cats and dogs often appear in various images. The processing on the images of cats and dogs is generally the overall processing, such as processing the entire body of the cat. More detailed local processing needs to be processed by post-production, which is more cumbersome and not easy for ordinary users. Therefore, it is desired to provide a simple technical solution that can perform special effects on animal images.

### SUMMARY

In a first aspect, a method for processing an animal face image is provided according to an embodiment of the present disclosure. The method includes: acquiring an input image including at least one animal; recognizing a face image of the animal in the image; reading a configuration file for image processing, the configuration file including parameters of the image processing; and processing the face image of the animal according to the parameters of the image processing to obtain a processed face image of the animal.

Further, the acquiring an input image including at least one animal includes: acquiring a video image including multiple video frames, where at least one of the multiple video frames includes at least one animal.

Further, the recognizing a face image of the animal in the image includes: recognizing a face image of an animal in a current video frame.

Further, the recognizing a face image of the animal in the image includes: recognizing a face region of the animal in the image, and detecting key points of the face image of the animal in the face region.

Further, the reading a configuration file for image processing, the configuration file including parameters of the image processing includes: reading a configuration file for image processing, the configuration file including a type parameter and a position parameter of the image processing, where the position parameter is associated with the key points.

Further, the processing the face image of the animal according to the parameters of the image processing to obtain a processed face image of the animal includes: processing the face image of the animal according to the type parameter of the image processing and the key points of the face image of the animal to obtain the processed face image of the animal.

Further, the processing the face image of the animal according to the type parameter of the image processing and the key points of the face image of the animal to obtain the processed face image of the animal includes: acquiring a material required for the image processing in a case that the type parameter of the image processing is texture processing; and rendering the material to a predetermined position of the face image of the animal according to the key points of the face image of the animal, to obtain an animal face image with the material.

Further, the processing the face image of the animal according to the type parameter of the image processing and the key points of the face image of the animal, to obtain the processed face image of the animal includes: in a case that the type parameter of the image processing is a deformation type, acquiring a key point related to the deformation type; and moving the key point related to the deformation type to a predetermined position to obtain a deformed face image of the animal.

Further, the recognizing a face image of the animal in the image includes: recognizing face images of multiple animals in the image, and assigning animal face IDs respectively for the face images of the animals according to a recognition order.

Further, the reading a configuration file for image processing, the configuration file including parameters of the image processing includes: reading a configuration file for image processing, and acquiring, according to each of the animal face IDs, parameters of the image processing corresponding to the animal face ID.

In a second aspect, an apparatus for processing an animal face image is provided according to an embodiment of the present disclosure. The apparatus includes: an image acquisition module, an animal face recognition module, a configuration file reading module and an image processing module. The image acquisition module is configured to acquire an input image including at least one animal. The animal face recognition module is configured to recognize a face image of the animal in the image. The configuration file reading module is configured to read a configuration file for image processing, the configuration file including parameters of the image processing. The image processing module is configured to process the face image of the animal according to the parameters of the image processing to obtain a processed face image of the animal.

Further, the image acquisition module further includes a video image acquisition module. The video image acquisition module is configured to acquire a video image. The video image includes multiple video frames. At least one of the multiple video frames includes at least one animal.

Further, the animal face recognition module further includes a video animal face recognition module. The video animal face recognition module is configured to recognize a face image of an animal in a current video frame.

Further, the animal face recognition module further includes a key point detection module. The key point detection module is configured to recognize a face region of the animal in the image, and detect key points of the face image of the animal in the face region.

Further, the configuration file reading module includes a first configuration file reading module. The first configuration file reading module is configured to read a configuration file for image processing. The configuration file includes a type parameter and position parameter of the image processing. The position parameter is associated with the key points.

Further, the image processing module further includes a first image processing module. The first image processing module is configured to process the face image of the animal according to the type parameter of the image processing and the key points of the face image of the animal to obtain the processed face image of the animal.

Further, the first image processing module further includes a material acquisition module and a texture processing module. The material acquisition module is configured to acquire a material required for the image processing in a case that the type parameter of the image processing is texture processing. The texture processing module is configured to render the material to a predetermined position of the face image of the animal according to the key points of the face image of the animal, to obtain an animal face image with the material.

Further, the first image processing module further includes a key point acquisition module and a deformation processing module. The key point acquisition module is configured to: in a case that the type parameter of the image processing is a deformation type, acquire a key point related to the deformation type. The deformation processing module is configured to move the key point related to the deformation type to a predetermined position to obtain a deformed face image of the animal.

Further, the animal face recognition module further includes: an ID assignment module. The ID assignment module is configured to recognize face images of multiple animals in the image, and assign animal face IDs respectively for the face images of the animals according to a recognition order. The configuration file reading module further includes: a processing parameter acquisition module. The processing parameter acquisition module is configured to read a configuration file for image processing, and acquire, according to each of the animal face IDs, parameters of the image processing corresponding to the animal face ID.

In a third aspect, an electronic device is provided according to an embodiment of the present disclosure. The electronic device includes: at least one processor and a memory communicatively connected to the at least one processor. The memory stores instructions that is executable by the at least one processor. The instructions are executed by the at least one processor to cause the at least one processor to perform the method for processing an animal face image described in the first aspect.

In a fourth aspect, a non-transitory computer readable storage medium having computer instructions stored thereon is provided according to an embodiment of the present disclosure. The computer instructions cause a computer to perform the method for processing an animal face image described in the first aspect.

There are provided a method and an apparatus for processing an animal face image, an electronic device and a computer readable storage medium according to embodiments of the present disclosure. The method for processing an animal face image includes: acquiring an input image including at least one animal; recognizing a face image of the animal in the image; reading a configuration file for image processing, the configuration file including parameters of the image processing; and processing the face image of the animal according to the parameters of the image processing to obtain a processed face image of the animal. According to the embodiments of the present disclosure, the face image of the animal in the image is recognized and is processed according to the image processing configuration in the configuration file to obtain different special effects, so that the problems in the conventional technology that face image of animal needs to be processed by means of post-production and that the production of special effects is not flexible can be solved.

The above description is only an overview of the technical solutions of the present disclosure. In order to more clearly understand technical means used in the present disclosure to implement the present disclosure as stated in this specification, and to more clearly understood the above and other objects, features and advantages of the present disclosure, preferred embodiments are described in detail below with reference to the drawings.

### BRIEF DESCRIPTION OF THE DRAWINGS

In order to more clearly illustrate the technical solutions in the embodiments of the present disclosure or in the conventional technology, the drawings to be used in the description of the embodiments or the conventional technology are briefly described below. Apparently, the drawings in the following description only show some embodiments of the present disclosure, and other drawings may be obtained by those skilled in the art from the drawings without any creative work.

FIG. 1 is a flowchart showing a first example of a method for processing an animal face image according to an embodiment of the present disclosure;

FIG. 2a is a schematic diagram showing key points of a cat face used in the method for processing an animal face image according to the embodiment of the present disclosure:

FIG. 2b is a schematic diagram showing key points of a dog face used in the method for processing an animal face image according to the embodiment of the present disclosure;

FIG. 3 is a flowchart showing a second example of the method for processing an animal face image according to the embodiment of the present disclosure;

FIG. 4 is a schematic structural diagram showing a first example of an apparatus for processing an animal face image according to an embodiment of the present disclosure;

FIG. 5 is a schematic structural diagram showing an animal face recognition module and a configuration file reading module in a second example of the apparatus for processing an animal face image according to the embodiment of the present disclosure; and

FIG. 6 is a schematic structural diagram of an electronic device according to an embodiment of the present disclosure.

### DETAILED DESCRIPTION OF EMBODIMENTS

Embodiments of the present disclosure are described below by specific examples, and those skilled in the art may easily understand other advantages and effects of the present disclosure based on contents disclosed in this specification. It is apparent that the described embodiments are only a part of the embodiments of the present disclosure, rather than all embodiments. The present disclosure may be implemented or applied by various other specific embodiments, and various modifications and changes may be made to details of this specification based on different views and applications without departing from the spirit of the present disclosure. It should be noted that the following embodiments and features in the embodiments may be combined with each other without conflict. All other embodiments obtained by those skilled in the art based on the embodiments of the present disclosure without any creative work fall in the protection scope of the present disclosure.

It should be noted that various aspects of the embodiments within the scope of the appended claims are described below. It is apparent that, the aspects described herein may be embodied in a wide variety of forms, and any particular structure and/or function described herein is merely illustrative. Based on the present disclosure, those skilled in the art should appreciate that, one aspect described herein may be implemented independently of any other aspects and two or more of these aspects may be combined in various ways. For example, the device and/or method may be implemented using any number of the aspects set forth herein. In addition, the device and/or method may be implemented using other structures and/or functionalities than one or more of the aspects set forth herein.

It should further be noted that the drawings provided in the following embodiments merely illustrate the basic concept of the present disclosure in a schematic manner, and only components related to the present disclosure are shown in the drawings. The drawings are not drawn based on the number, the shape and the size of components in actual implementation. The type, the number and the proportion of the components may be changed randomly in the actual implementation, and a layout of the components may be more complicated.

In addition, in the following description, specific details are provided to facilitate a thorough understanding of the examples. However, those skilled in the art should appreciate that the aspects may be practiced without these specific details.

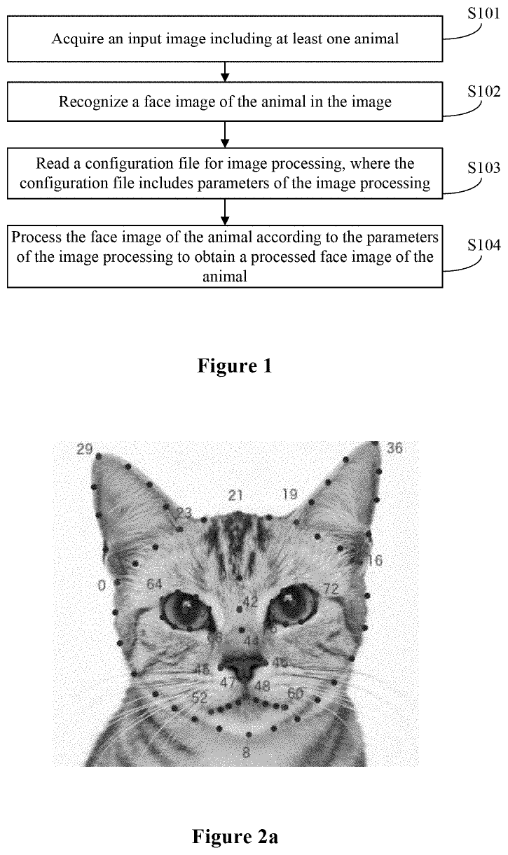

FIG. 1 is a flowchart showing a first example of a method for processing an animal face image according to an embodiment of the present disclosure. The method for processing an animal face image provided in this embodiment is performed by an apparatus for processing an animal face image. The apparatus for processing an animal face image can be implemented as software or a combination of software and hardware. The apparatus for processing an animal face image can be integrated in a device in an image processing system, for example, in an image processing server or an image processing terminal device. As shown in FIG. 1, the method includes the following steps S101 to S104.

In step S101, an input image is acquired. The image includes at least one animal.

In an embodiment, the input image is acquired from a local storage space or a network storage space. No matter where the input image is acquired, a storage address of the input image is firstly required to be acquired, and the input image is acquired from the storage address. The input image may be a video image or a picture, or a picture with dynamic effects, which is not repeated herein.

In an embodiment, the input image is acquired by acquiring a video image. The video image includes multiple video frames, and at least one of the multiple video frames includes at least one animal. In this embodiment, the input video image may be acquired by an image sensor. The image sensor refers to various devices that can collect images, and typical image sensors include video cameras, webcams, cameras, etc. In this embodiment, the image sensor may be a camera on a mobile terminal, such as a front or rear camera on a smart phone. A video image collected by the camera may be directly displayed on a display screen of the phone. In this step, acquiring the video image taken by the image sensor is used for further image recognition in a next step.

In this step, the input image includes at least one animal. The image of the animal is the basis for recognizing a face image of the animal. In this embodiment, if the input image is a picture, the picture includes an image of at least one animal. If the input image is a video, at least one of video frames in the input image includes an image of at least one animal.

In step S102, a face image of the animal in the image is recognized.

In this step, the face image of the animal in the image is recognized by recognizing a face region of the animal in the image and detecting key points of the face image of the animal in the face region. Recognizing the face region of the animal in the image may be performed by roughly recognizing an image region with the face of the animal in the image and selecting the region with a block, so as to further detect key points in the face region. In recognizing the face region of the animal, a classifier may be used to classify the face of the animal in the image to obtain the face region of the animal. Specifically, the classification may be performed multiple times. A rough classification is firstly performed, and a fine classification is performed on an image obtained by the rough classification, to obtain a final classification result.

In a specific implementation, the face image of the animal is grayed firstly to convert the image into a gray image, and a first feature of the gray image is extracted. The first feature is represented by a difference between a stun of gray values of all pixels in one of multiple rectangles having the same shape and size on the image and a sum of gray values of all pixels in another rectangle among the multiple rectangles, and the first feature reflects a local gray change of the image. First features of images in a training set are used to train a basic classifier, and first N basic classifiers with the best classification ability are combined to obtain a first classifier. Weight values may be applied to samples and basic classifiers in the training set. A weight value of a sample indicates how difficult the sample is correctly classified. The samples initially correspond to the same weight value, and a basic classifier h1 is trained under this sample distribution. For a sample that is incorrectly classified by h1, the weight value of the sample is increased. For a sample that is correctly classified by h1, the weight value of the sample is decreased. In this way, the new sample distribution highlights the incorrectly classified samples, so that the basic classifier can focus more on these incorrectly classified samples in the next training. A weight value of a basic classifier indicates a classification ability of the basic classifier. A basic classifier incorrectly classifying a small number of samples has a large weight, indicating that the classification ability of the basic classifier is good. Under the new sample distribution, the weak classifier hi is trained to obtain a basic classifier h2 and a weight thereof. After N times of iteration, N basic classifiers h1, h2, h3, . . . , and hN, and N corresponding weight values are obtained. The h1, h2, h3, . . . , and hN are accumulated according to the weight values to form the first classifier. The training set includes positive samples and negative samples. The positive samples include animal face images, and the negative samples include no animal face image.

The animal face images belong to a same type of animal. For example, all the animal face images are dog face images or all the animal face images are cat face images. An individual first classifier is trained for each type of animal. The image is classified by the first classifier to obtain a first classification result.

The classification result of the first classifier is classified by a second classifier. The second classifier may classify the animal face image with a second feature. The second feature may be a directional gradient histogram feature, and the second classifier may be a support vector machine classifier. The directional gradient histogram feature of the image in the classification result of the first classifier is acquired, and the image in the classification result of the first classifier is classified by the support vector machine classifier to obtain a final classification result, i.e., an input image containing a face image of a specific animal and an image region of the face image of the specific animal. Samples that are incorrectly classified by the second classifier may be put into the negative samples of the first classifier, and the weight values thereof are adjusted to provide feedback for adjustment of the first classifier.

Under the classification of the first classifier and the second classifier, the face region of the animal in the image is obtained. The key points of the animal face are detected in the region. The detection may be implemented by a deep learning method. On the basis of the face image region, positions of key points on the animal face may be predicted in the region firstly, and precise positioning is performed according to different regions on the animal face. The different regions may be determined according to organs of the animal face, such as an eye region, a nose region, and a mouth region. Finally, contour key points of the face are detected and combined to form complete key points.

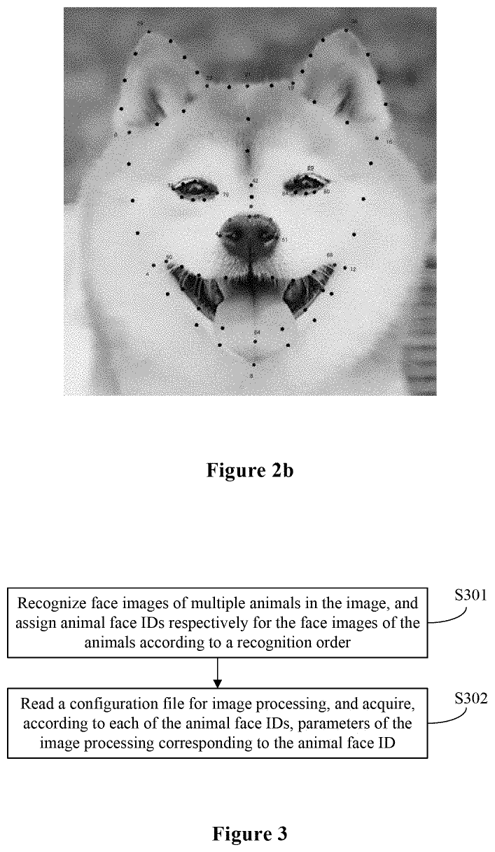

Typical animal face key points are shown in FIGS. 2a and 2b. FIG. 2a shows a cat face with 82 key points, and FIG. 2b shows a dog face with 90 key points. Key points with digital marks are semantic points. For example, a point marked with 0 in the cat face represents a lower root of an ear on the left, and a point marked with 8 is a chin point. Points marked with 1 to 7 have no specific meaning, which are points for dividing a part between 0 and 8 into equal parts are close to the edge of the contour. Other key points are similar and are not repeated herein. Recognizing these key points facilitates the subsequent image processing.

In an embodiment, the input image in step S101 is a video image. In this case, recognizing the face image of the animal in the image is implemented by recognizing a face image of an animal in a current video frame. In this embodiment, each frame of image is used as an input image, and key points of the face image of the animal are recognized by the above recognition method, so that the face image of the animal can be dynamically identified and tracked even if the face of the animal moves in the video.

It should be understood that the recognition method for the animal face described above is only an example. In practice, any method by which a face image of an animal can be recognized and key points of a face of the animal can be detected is applicable to the technical solution of the present disclosure, which is not limited in the present disclosure.

In step S103, a configuration file for image processing is read. The configuration file includes parameters of the image processing.

In this step, the configuration file includes a type parameter and a position parameter of the image processing. The type parameter is used to decide a type of the image processing. Optionally, the type may be a texture processing type or a deformation processing type. The position parameter is used to identify a position where image processing is required. Optionally, the position parameter may be an absolute position of the image, for example, UV coordinates of the image or various other coordinates. Optionally, the position parameter may be associated with the key points recognized in step S102. Since each key point is associated with the face of the animal, an effect of the processed image moving with movement of the animal face can be achieved.

Typically, for the texture type, in the case that the position parameter is associated with the key point, the position parameter describes a display position of a material required for the image processing is associated with which animal face key points. The display position of the material may be associated with all key points by default, or the material may be set to follow several key points. In addition to the position parameter, the configuration file further includes a positional relationship parameter “point” between the material and the key points. The “point” may include two groups of associated points, where “point0” means a first group of associated points, and “point1” means a second group of associated points. For each group of associated points, the “point” describes a position of an anchor point in the camera, which is obtained by performing the weighted average on several groups of key points and weights thereof. A field “Dix” is used to describe serial numbers of the key points. Specifically, it is set that, the material follows 4 key points of the animal face, namely key points 9, 10, 11 and 12, and the weight of each key point is 0.25, and coordinates of each key point are (X9, Y9), (X10, Y10), (X11, Y11), and (X12, Y12). In this case, an X-axis coordinate of the anchor point fo1llowed by the material is calculated as Xa=X9*0.25+X10*0.25+X11*0.25+X12*0.25, and a Y-axis coordinate of the anchor point is calculated as Ya=Y9*0.25+Y10*0.25+Y11*0.25+Y12*0.25. It should be understood that the “point” may include any group of related points, and is not limited to two groups. In the above specific example, two anchor points are obtained, and the material moves following positions of the two anchor points. In practice, there may be more than two anchor points, which is related to the number of groups of association points used. The coordinates of each key point may be obtained from the key points detected in step S102.

For the texture type, the configuration file may further include a relationship between a scaling degree of the material and the key points. Parameters “scaleX” and “scaleY” are respectively used to describe scaling requirements in the x and y directions, respectively. For each direction, two parameters “start_idx” and “end idx” are included, which correspond to two key points. The distance between the two key points is multiplied by a value of “factor” to obtain an intensity of the scaling. The factor is a preset value, which may be any value. For the scaling, if there is only one group of associated points “point0” in the “position”, the x direction is the actual horizontal right direction, and the y direction is the actual vertical downward direction. Both “scaleX” and “scaleY” are valid. If there is any one missing, the scaling is performed by an original aspect ratio of the material according to the existing parameter. If there are both “point0” and “point1” in the “position”, the x direction is a vector direction obtained by point Lanchor-point0.anchor, and the y direction is determined by rotating the x direction 90 degrees clockwise. The “scaleX” is invalid, and the scaling of the x direction is determined by the following of the anchor point. The “scaleY” is valid. If the “scaleY” is missing, the scaling is performed by the original aspect ratio of the material.

For the texture type, the configuration file may further include a rotation parameter “rotationtype” of the material. The rotation parameter is valid only if there is only “point0” in the “position”. The rotation parameter may include two values 0 and 1, where 0 represents requiring no rotation, and 1 represents requiring rotation according to a related angle value of the key point.

For the texture type, the configuration file may further include a rendering blending mode. The rendering blending refers to mixing two colors together. Specifically, in the present disclosure, the rendering blending refers to blending a color of a certain pixel position with a color to be drawn together to achieve special effects. The rendering blending mode refers to a method used for blending. Generally speaking, the blending method refers to calculation of a source color and a target color to obtain a mixed color. In practical applications, the calculation is generally performed on a result obtained by multiplying the source color by a source factor and a result obtained by multiplying the target color by a target factor to obtain the mixed color. For example, the calculation is an addition operation. In this case, BLENDcolor=SRC_color*SCR_factor+DST_color*DST_factor, where 0≤SCR_factor≤1, and 0≤DST_factor≤1. According to the above calculation formula, it is assumed that, four components (referring to red, green, blue, and alpha values) of the source color are represented by (Rs, Gs, Bs, As), and four components of the target color are represented by (Rd, Gd, Bd, Ad), the source factor is set to (Sr, Sg, Sb, Sa), and the target factor is set to (Dr, Dg, Db, Da). The new color formed by blending may be expressed as: (Rs*Sr+Rd*Dr, Gs*Sg+Gd*Dg, Bs*Sb+Bd*Db, As*Sa+Ad*Da), where the alpha value represents transparency, 0≤alpha≤1. The above blending method is just an example. In practical applications, the blending method may be defined or selected yourself. The calculation may be the operation of addition, subtraction, multiplication, division, taking the larger of the two, taking the smaller of the two, and logical operation (AND, OR, XOR, etc.). The above blending method is just an example. In practical applications, the blending method may be defined or selected yourself. The calculation may be the operation of addition, subtraction, multiplication, division, taking the larger of the two, taking the smaller of the two, and logical operation (AND, OR, XOR, etc.).

For the texture type, the configuration file may further include a rendering order. The rendering order includes: a rendering order between sequence frames of the material. This order may be defined by a parameter “zorder”. A small value of the “zorder” corresponds to an early rendering order. The rendering order further includes a rendering order between the material and the animal face image. This order may be determined in a variety of ways. Typically, it may also be determined in a manner similar to “zorder”. It may be directly set that the animal face is to be rendered firstly or the material is to be rendered firstly.

For the deformation type, in the case that the position parameter is associated with the key point, the position parameter describes a position of the deformation is associated with which animal face key points. Optionally, the type of deformation may specifically be enlargement, and the enlarged region may be determined by the key points. For example, if the eyes on an animal face are enlarged, the position parameter is the key point representing the eyes. Optionally, the type of deformation may specifically be dragging, and the position parameter may be a key point to be dragged, and so on. The deformation type may be at least one or a combination of enlargement, reduction, translation, rotation, and dragging.

For the deformation type, the configuration file may further include a deformation degree parameter. The degree of the deformation may be, for example, multiples of the enlargement and the reduction, a translation distance, a rotation angle, and a dragging distance. In the case that the deformation type is translation, the deformation degree parameter includes a position of a target point and an amplitude of the translation from a center point to the target point. The amplitude may be a negative value, indicating translation in the opposite direction. The deformation degree parameter may further include a translational attenuation coefficient. A large translational attenuation coefficient corresponds to a small attenuation of the translation amplitude in the direction away from the center point. The deformation type further includes a special type of deformation, i.e., flexible enlargement/reduction, for freely adjusting the degree of image deformation of image positions at different distances from the center point in the deformed region.

It should be understood that the above-mentioned image processing type and the specific parameters corresponding to the image processing type are used to illustrate specific examples of the technical solutions of the present disclosure, rather than limiting the present disclosure. In practice, any image processing type conforming to the scenario of the present disclosure, such as filtering, beautification and blurring can be applied in the present disclosure, and the parameters used may be different from those in the above-mentioned specific examples, which are not repeated herein.

In step S104, according to the parameters of the image processing, the face image of the animal is processed to obtain a processed face image of the animal;

In this step, the face image of the animal may be processed according to the type parameter of the image processing and the key points of the face image of the animal to obtain the processed face image of the animal.

Specifically, in the case that the type parameter of the image processing is the texture processing, a material required for the image processing is acquired, the material is rendered to a predetermined position of the face image of the animal according to the key points of the face image of the animal, to obtain an animal face image with the material. In this embodiment, the texture includes multiple materials. Storage addresses of the materials may be stored in the configuration file in step S103. Optionally, the material may be a pair of glasses. In this case, the key points of the face image of the animal are the position parameters in step S103, which may be eye positions of the animal in this specific example. The pair of glasses is rendered to the eye positions of the animal, to obtain an animal face image with the pair of glasses.

Specifically, in the case that the type parameter of the image processing is the deformation type, a key point related to the deformation type is acquired, and the key point related to the deformation type is moved to a predetermined position to obtain a deformed face image of the animal. Optionally, the deformation type is enlargement, and the key point related to the deformation type is an eye key point. In this case, the degree of enlargement may be obtained according to a deformation degree parameter in the configuration file, a position of the eye key point after enlargement is calculated, and all eye key points are moved to enlarged positions, to obtain the animal face image with enlarged eyes.

It should be understood that the above-mentioned texture processing and deformation processing are merely examples for illustrating the technical solution, and do not limit the present disclosure. Any other processing can be configured in the configuration file and applied to the present disclosure, which is not repeated herein.

As shown in FIG. 2, in another embodiment of the animation generation method provided in the present disclosure, step S102 of recognizing the face image of the animal in the image includes step S301.

In step S301, face images of multiple animals in the image are recognized, and animal face IDs are assigned respectively for the face images of the animals according to a recognition order.

Step S103 of reading the configuration file for the image processing, the configuration file including parameters of the image processing includes step S302.

In step S302, the configuration file for image processing is read, and according to each of the animal face IDs, parameters of the image processing corresponding to the animal face ID are acquired.

In this embodiment, the image processing can be performed on face images of multiple animals in the image. The face images of the multiple animals are recognized, and the recognized animal face images are respectively assigned with animal face IDs according to the recognition order or any other order. Processing parameters corresponding to each ID are configured in the configuration file in advance, including a processing type, a processing position, and various other necessary processing parameters. In this way, according to the configuration in the configuration file, different processing can be performed for different recognized animal faces, to achieve a better effect.

There are provided a method and an apparatus for processing an animal face image, an electronic device and a computer readable storage medium according to embodiments of the present disclosure. The method for processing an animal face image includes: acquiring an input image including at least one animal; recognizing a face image of the animal in the image; reading a configuration file for image processing, the configuration file including parameters of the image processing; and processing the face image of the animal according to the parameters of the image processing to obtain a processed face image of the animal. According to the embodiments of the present disclosure, the face image of the animal in the image is recognized and is processed according to the image processing configuration in the configuration file to obtain different special effects, so that the problems in the conventional technology that face image of animal needs to be processed by means of post-production and that the production of special effects is not flexible can be solved.

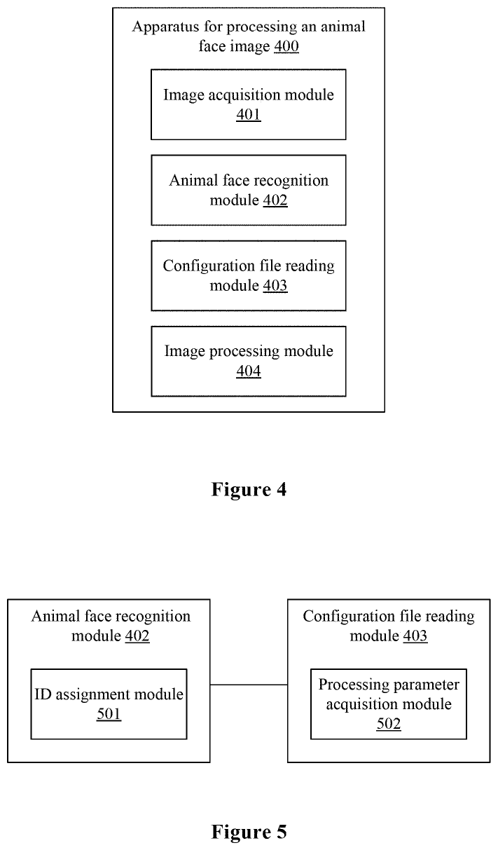

FIG. 4 is a schematic structural diagram showing a first example of an apparatus 400 for processing an animal face image according to an embodiment of the present disclosure. As shown in FIG. 4, the apparatus includes: an image acquisition module 401, an animal face recognition module 402, a configuration file reading module 403 and an image processing module 404.

The image acquisition module 401 is configured to acquire an input image. The image includes at least one animal.

The animal face recognition module 402 is configured to recognize a face image of the animal in the image.

The configuration file reading module 403 is configured to read a configuration file for image processing, where the configuration file includes parameters of the image processing.

The image processing module 404 is configured to process the face image of the animal according to the parameters of the image processing to obtain a processed face image of the animal.

Further, the image acquisition module 401 further includes a video image acquisition module.

The video image acquisition module is configured to acquire a video image. The video image includes multiple video frames. At least one of the multiple video frames includes at least one animal.

Further, the animal face recognition module 402 further includes a video animal face recognition module.

The video animal face recognition module is configured to recognize a face image of an animal in a current video frame.

Further, the animal face recognition module 402 further includes a key point detection module.

The key point detection module is configured to recognize a face region of the animal in the image, and detect key points of the face image of the animal in the face region.

Further, the configuration file reading module 403 includes a first configuration file reading module.

The first configuration file reading module is configured to read a configuration file for image processing. The configuration file includes a type parameter and position parameter of the image processing. The position parameter is associated with the key points.

Further, the image processing module 404 further includes a first image processing module.

The first image processing module is configured to process the face image of the animal according to the type parameter of the image processing and the key points of the face image of the animal to obtain the processed face image of the animal.

Further, the first image processing module further includes a material acquisition module and a texture processing module.

The material acquisition module is configured to acquire a material required for the image processing in a case that the type parameter of the image processing is texture processing.

The texture processing module is configured to render the material to a predetermined position of the face image of the animal according to the key points of the face image of the animal, to obtain an animal face image with the material.

Further, the first image processing module further includes a key point acquisition module and a deformation processing module.

The key point acquisition module is configured to: in a case that the type parameter of the image processing is a deformation type, acquire a key point related to the deformation type.

The deformation processing module is configured to move the key point related to the deformation type to a predetermined position to obtain a deformed face image of the animal.

The apparatus shown in FIG. 4 can perform the method in the embodiment shown in FIG. 1. For parts that are not described in detail in this example, reference may be made to the related description of the embodiment shown in FIG. 1. For the implementation process and technical effects of this technical solution, reference is made to the description in the embodiment shown in FIG. 1, which is not repeated herein.

In a second example of the apparatus for processing an animal face image provided in the embodiment of the present disclosure, as shown in FIG. 5, the animal face recognition module 402 further includes: an ID assignment module 501. The ID assignment module is configured to recognize face images of multiple animals in the image, and assign animal face IDs respectively for the face images of the animals according to a recognition order. The configuration file reading module 403 further includes: a processing parameter acquisition module 502. The processing parameter acquisition module is configured to read a configuration file for image processing, and acquire, according to each of the animal face IDs, parameters of the image processing corresponding to the animal face ID.

The apparatus in the second example can perform the method in the embodiment shown in FIG. 3. For parts that are not described in detail in this example, reference may be made to the related description of the embodiment shown in FIG. 3. For the implementation process and technical effects of this technical solution, reference is made to the description in the embodiment shown in FIG. 3, which is not repeated herein.

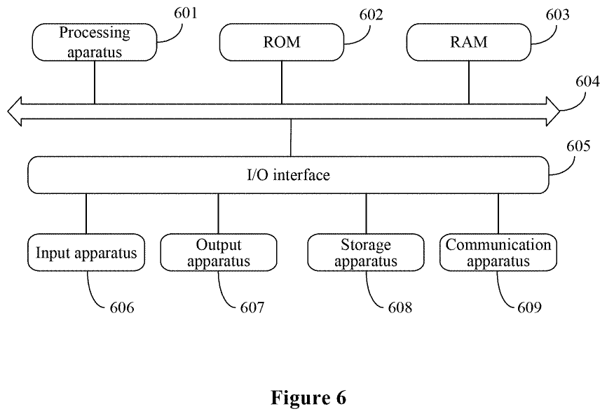

Reference is made to FIG. 6, which is a schematic structural diagram of an electronic device 600 applicable to implement the embodiments of the present disclosure. The electronic devices according to the embodiments of the present disclosure may include, but are not limited to, mobile terminals such as mobile phones, notebook computers, digital broadcast receivers, personal digital assistants (PDAs), tablets (PADS), portable multimedia players (PMPs) and vehicle-mounted terminals (for example, car navigation terminals), and fixed terminals such as digital TVs and desktop computers. The electronic device shown in FIG. 6 is provided only for illustration rather than limitation to functions and applications of the embodiments of the present disclosure.

As shown in FIG. 6, the electronic device 600 includes a processing apparatus 601 (for example, a central processor and a graphics processor). The processing apparatus 601 may perform various proper operations and processing based on programs stored in a read-only memory (ROM) 602 or programs loaded from a storage apparatus 608 to a random-access memory (RAM) 603. The RAM 603 also stores various data and programs required for operations of the electronic device 600. The processing apparatus 601, the ROM 602, and the RAM 603 are connected to each other via a bus 604. An input/output (I/O) interface 605 is also connected to the bus 604.

The following apparatuses may be connected to the I/O interface 605, including: an input apparatus 606 such as a touch screen, a touch pad, a keyboard, a mouse, an image sensor, a microphone, an accelerometer and a gyroscope; an output apparatus 607 such as a liquid crystal display (LCD), a speaker, and a vibrator; a storage apparatus 608 such as a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that the electronic device 600 is not required to implement or have all the illustrated apparatuses. The electronic device 600 may be alternatively implemented or is provided with more or fewer apparatuses.

According to the embodiments of the present disclosure, the above processes described with reference to the flowcharts may be implemented as computer software programs. For example, a computer program product is provided according to an embodiment of the present disclosure. The computer program product includes a computer program carried by a computer readable medium. The computer program includes program codes for performing the method shown in the flowcharts. In this embodiment, the computer program may be downloaded and installed from Internet via the communication apparatus 609, or may be installed from the storage apparatus 608 or the ROM 602. The computer program, when being executed by the processing apparatus 601, can realize the above functions specified in the method in the present disclosure.

It should be noted that, the computer readable medium in the present disclosure may be a computer readable signal medium, a computer readable storage medium, or any combination thereof The computer readable storage medium may be but is not limited to a system, apparatus, or device in an electronic, magnetic, optical, electromagnetic, infrared, or semi-conductive form, or any combination thereof Specifically, the computer readable storage medium may be but is not limited to an electric connection having one or more wires, a portable computer disk, a hard disk, a random-access memory (RAM), a read-only memory (ROM), an erasable programmable read-only memory (EPROM or a flash memory), an optical fiber, a portable compact disc read-only memory (CD-ROM), a light storage device, a magnetic storage device or any combination thereof In the present disclosure, the computer readable storage medium may be any tangible medium including or storing a program. The program may be used by or with a command execution system, apparatus or device. In the present disclosure, the computer readable signal medium may be a data signal transmitted in a baseband or transmitted as a part of a carrier wave, where the data signal carries computer readable program codes. The transmitted data signal may be in various forms, including but not limited to an electromagnetic signal, an optical signal or any proper combination thereof. The computer readable signal medium may further be any computer readable medium other than the computer readable storage medium. The computer readable signal medium can send, transmit or transfer the program that is used by or with a command execution system, apparatus or device. Program codes stored in the computer readable medium may be transmitted via any proper medium including but not limited to, a wire, an optical cable, radio frequency (RF) and the like, or any proper combination thereof.

The above-mentioned computer readable medium may be included in the above-mentioned electronic device; or it may exist alone without being assembled into the electronic device.

The above-mentioned computer readable medium carries one or more programs. When the above-mentioned one or more programs are executed by the electronic device, the one or more programs cause the electronic device to: acquire an input image including at least one animal; recognize a face image of the animal in the image; read a configuration file for image processing, the configuration file including parameters of the image processing; and process the face image of the animal according to the parameters of the image processing to obtain a processed face image of the animal.

Computer program codes for executing operation of the present disclosure may be written in one or more programming languages or a combination thereof. The programming languages may include an object-oriented programming language such as Java, Smalltalk, C++, and may further include a conventional procedural programming language such as “C” or the like. The program codes may be completely or partly executed on a user computer, or executed as a standalone software package. Alternatively, one part of the program codes may be executed on a user computer and the other part of the program codes may be executed on a remote computer, or the program codes may be executed on a remote computer or a server completely. In a case that the program codes are executed on a remote computer completely or partly, the remote computer may be connected to the user computer via any network such as a local area network (LAN) or a wide area network (WAN). Alternatively, the remote computer may be connected to an external computer (for example, the remote computer is connected to the external computer via the Internet provided by an Internet service provider).

The flowcharts and the block diagrams illustrate system structures, functions and operations that may be implemented with the system, the method, and the computer program product according to the embodiments of the present disclosure. In this case, each block in the flowcharts or the block diagrams may represent a module, a program segment, or a part of codes. The module, the program segment, or the part of codes may include one or more executable instructions for implementing a specified logical function. It should be noted that, in some alternative implementations, the functions shown in blocks may be performed in an order different from that indicated in the drawings. For example, steps shown in two adjacent blocks may be performed almost in parallel, or may be performed in reverse order, which is determined based on the functions. It should be further noted that, a function shown in each block of the flowcharts and/or block diagrams, or shown in a combination of blocks of the flowcharts and/or block diagrams may be implemented by a hardware-based system dedicated for performing specified functions or operations, or may be implemented by a combination of a dedicated hardware and computer instructions.

The units involved in the embodiments of the present disclosure may be implemented by hardware or software. Names of the units are not intended to limit the units. For example, the acquiring unit may be described as a unit for acquiring a target human body image.

The above describes only preferred embodiments and technical principles used in the present disclosure. It should be understood by those skilled in the art that, the invention scope of the present disclosure is not limited to the technical solutions formed by the specific combinations of the above technical features, and should further cover other technical solutions formed by any combination of the above technical features or equivalent features of the above technical features without departing from the above invention concept, for example, technical solutions formed by interchanging the above features and the technical features having the similar functions as described (but not limited to those) in the present disclosure.

1. A method for processing an animal face image, the method comprising:
acquiring an input image comprising at least one animal;
recognizing a face image of the animal in the image;
reading a configuration file for image processing, the configuration file comprising parameters of the image processing; and
processing the face image of the animal according to the parameters of the image processing to obtain a processed face image of the animal.

2. The method for processing an animal face image according to claim 1, wherein the acquiring an input image comprising at least one animal comprises:
acquiring a video image comprising a plurality of video frames, wherein at least one of the plurality of video frames comprises at least one animal.

3. The method for processing an animal face image according to claim 2, wherein the recognizing a face image of the animal in the image comprises:
recognizing a face image of an animal in a current video frame.

4. The method for processing an animal face image according to claim 1, wherein the recognizing a face image of the animal in the image comprises:
recognizing a face region of the animal in the image, and detecting key points of the face image of the animal in the face region.

5. The method for processing an animal face image according to claim 4, wherein the reading a configuration file for image processing, the configuration file comprising parameters of the image processing comprises:
reading a configuration file for image processing, the configuration file comprising a type parameter and a position parameter of the image processing, wherein the position parameter is associated with the key points.

6. The method for processing an animal face image according to claim 5, wherein the processing the face image of the animal according to the parameters of the image processing to obtain a processed face image of the animal comprises:
processing the face image of the animal according to the type parameter of the image processing and the key points of the face image of the animal to obtain the processed face image of the animal.

7. The method for processing an animal face image according to claim 6, wherein the processing the face image of the animal according to the type parameter of the image processing and the key points of the face image of the animal to obtain the processed face image of the animal comprises:
acquiring a material required for the image processing in a case that the type parameter of the image processing is texture processing; and
rendering the material to a predetermined position of the face image of the animal according to the key points of the face image of the animal, to obtain an animal face image with the material.

8. The method for processing an animal face image according to claim 6, wherein the processing the face image of the animal according to the type parameter of the image processing and the key points of the face image of the animal, to obtain the processed face image of the animal comprises:
in a case that the type parameter of the image processing is a deformation type, acquiring a key point related to the deformation type; and
moving the key point related to the deformation type to a predetermined position to obtain a deformed face image of the animal.

9. The method for processing an animal face image according to claim 1, wherein the recognizing a face image of the animal in the image comprises:
recognizing face images of a plurality of animals in the image, and assigning animal face IDs respectively for the face images of the animals according to a recognition order.

10. The method for processing an animal face image according to claim 9, wherein the reading a configuration file for image processing, the configuration file comprising parameters of the image processing comprises:
reading a configuration file for image processing, and acquiring, according to each of the animal face IDs, parameters of the image processing corresponding to the animal face ID.

11. (canceled)

12. An electronic device, comprising:
at least one processor; and
at least one memory communicatively coupled to the at least one processor and storing instructions that upon execution by the at least one processor cause the device to:
acquiring an input image comprising at least one animal;
recognizing a face image of the animal in the image;
reading a configuration file for image processing, the configuration file comprising parameters of the image processing; and
processing the face image of the animal according to the parameters of the image processing to obtain a processed face image of the animal.

13. A non-transitory computer readable storage medium having non-transitory computer readable instructions stored thereon, wherein when executed by a computer, the non-transitory computer readable instructions cause the computer to perform the method for processing an animal face image according to claim 1.

14. The electronic device according to claim 12, wherein the acquiring an input image comprising at least one animal comprises:
acquiring a video image comprising a plurality of video frames, wherein at least one of the plurality of video frames comprises at least one animal.

15. The electronic device according to claim 14, wherein the recognizing a face image of the animal in the image comprises:
recognizing a face image of an animal in a current video frame.

16. The electronic device according to claim 12, wherein the recognizing a face image of the animal in the image comprises:
recognizing a face region of the animal in the image, and detecting key points of the face image of the animal in the face region.

17. The electronic device according to claim 16, wherein the reading a configuration file for image processing, the configuration file comprising parameters of the image processing comprises:
reading a configuration file for image processing, the configuration file comprising a type parameter and a position parameter of the image processing, wherein the position parameter is associated with the key points.

18. The electronic device according to claim 17, wherein the processing the face image of the animal according to the parameters of the image processing to obtain a processed face image of the animal comprises:
processing the face image of the animal according to the type parameter of the image processing and the key points of the face image of the animal to obtain the processed face image of the animal.

19. The electronic device according to claim 18, wherein the processing the face image of the animal according to the type parameter of the image processing and the key points of the face image of the animal to obtain the processed face image of the animal comprises:
acquiring a material required for the image processing in a case that the type parameter of the image processing is texture processing; and
rendering the material to a predetermined position of the face image of the animal according to the key points of the face image of the animal, to obtain an animal face image with the material.

20. The electronic device according to claim 18, wherein the processing the face image of the animal according to the type parameter of the image processing and the key points of the face image of the animal, to obtain the processed face image of the animal comprises:
in a case that the type parameter of the image processing is a deformation type, acquiring a key point related to the deformation type; and
moving the key point related to the deformation type to a predetermined position to obtain a deformed face image of the animal.

21. The electronic device according to claim 12, wherein the recognizing a face image of the animal in the image comprises:
recognizing face images of a plurality of animals in the image, and assigning animal face IDs respectively for the face images of the animals according to a recognition order.
